(19) United States
(12) Patent Application Publication
(10) Pub. No.: US 2019/0322422 A1
(43) Pub. Date: Oct. 24, 2019

(54) REINFORCED POLYBAG WITH MESH WINDOW AND METHODS OF MANUFACTURING THE SAME

(71) Applicant: Chris Hoe Lam Lee, Caledon (CA)

(72) Inventor: Chris Hoe Lam Lee, Caledon (CA)

(21) Appl. No.: 16/282,541

(22) Filed: Feb. 22, 2019

Related U.S. Application Data
(60) Provisional application No. 62/659,745, filed on Apr. 19, 2018.

(51) Int. Cl. B65D 33/04; B65D 85/34; B65D 33/00; B65D 33/01; B29C 65/08; B29C 65/00; B31B 70/82; B31B 70/20; B31B 70/64

(52) U.S. Cl. CPC B65D 33/04; B65D 85/34; B65D 33/004; B65D 33/01; B29C 65/08; B29L 2031/7129; B29C 66/729; B31B 70/82; B31B 70/20; B31B 70/642; B31B 70/826; B29C 66/4326

(57) ABSTRACT

A reinforced polybag and methods of manufacturing the same are presented. A method of making a reinforced polybag involves: providing a plurality of walls; providing a hole in a wall of the plurality of walls such that a remaining portion of the wall separates the hole in the wall form a side edge of at least one side edge of the wall; forming the polybag out of the plurality of walls by attaching each wall in the plurality of walls along the at least one side edge of that wall to at least one adjoining wall; providing a synthetic resin fiber mesh cover to cover the hole in the wall; and attaching a peripheral portion of the synthetic resin fiber mesh cover the remaining portion to cover the hole in the wall. Each wall in the plurality of walls is made of a synthetic resin film.

### RELATED APPLICATIONS

This application claims priority from the U.S. provisional patent application No. 62/659,745, filed on Apr. 19, 2018 the contents of which is incorporated herein, in its entirety, by reference.

### TECHNICAL FIELD

The embodiments disclosed herein relate to polybags and, more particular, to a reinforced polybag with a mesh window and methods of manufacturing the same.

### INTRODUCTION

Polybags having a mesh surface portion are known. Nonetheless, there remains a need for an improved reinforced polybag with a mesh surface and method of making the same.

### SUMMARY

In accordance with an aspect of an embodiment of the present invention, there is provided a method of making a reinforced polybag, the method involving: i) providing a plurality of walls formable into the polybag, each wall in the plurality of walls being made of a synthetic resin film and being attachable along at least one side edge to at least one side edge of at least one adjoining wall in the plurality of walls; ii) providing a hole in a wall in the plurality of walls, such that a remaining portion of the wall separates the hole in the wall from a side edge of the at least one side edge of the wall; iii) forming the polybag out of the plurality of walls by attaching each wall in the plurality of walls along the at least one side edge of that wall to the at least one side edge of the at least one adjoining wall in the plurality of walls; iv) providing a synthetic resin fiber mesh cover to cover the hole in the wall; and, v) attaching a peripheral portion of the synthetic resin fiber mesh cover to the remaining portion of the wall to cover the hole in the wall.

In some embodiments, i) the at least one side edge of the wall includes a plurality of side edges of the wall; and ii) providing the hole in the wall involves providing the hole in the wall such that the remaining portion of the wall separates the hole in the wall from each side edge of the plurality of side edges of the wall.

In some embodiments, attaching the peripheral portion of the synthetic resin fiber mesh cover to the remaining portion of the wall involves attaching the peripheral portion of the synthetic resin fiber mesh cover to an inner sub-portion of the remaining portion of the wall adjacent the hole, such that an outer sub-portion of the remaining portion of the wall remains uncovered by of the synthetic resin fiber mesh.

In some embodiments, the method further includes providing indicia on the remaining portion of the wall.

In some embodiments, the method further includes providing indicia on the outer sub-portion of the remaining portion of the wall.

In some embodiments, attaching the peripheral portion of the synthetic resin fiber mesh cover to the remaining portion of the wall involves heat-sealing the peripheral portion of the synthetic resin fiber mesh cover to the inner sub-portion of the remaining portion of the wall.

In some embodiments, attaching the peripheral portion of the synthetic resin fiber mesh cover to the remaining portion of the wall involves ultrasonically welding the peripheral portion of the synthetic resin fiber mesh cover to the inner sub-portion of the remaining portion of the wall.

In some embodiments, attaching the peripheral portion of the synthetic resin fiber mesh cover to the remaining portion of the wall involves laminating the peripheral portion of the synthetic resin fiber mesh cover to the inner sub-portion of the remaining portion of the wall.

In some embodiments, the method further includes providing a first die and a second die, distinct from the first die, where i) providing the hole in the wall involves operating the first die to provide the hole in the wall; and ii) attaching the peripheral portion of the synthetic resin fiber mesh cover to the remaining portion of the wall to cover the hole in the wall involves drawing the synthetic resin fiber mesh cover over the hole and then operating the second die to attach the peripheral portion of the synthetic resin fiber mesh cover to the remaining portion of the wall to cover the hole in the wall.

In some embodiments, the second die is a heat sealing die dimensioned to heat seal around the hole in the wall.

In some embodiments, the second die is an ultrasonic welding die dimensioned to ultrasonically weld around the hole in the wall.

In some embodiments, the second die is a laminating die dimensioned to laminate around the hole in the wall.

In some embodiments, forming the polybag out of the plurality of walls involves first cutting the plurality of walls and then, for each wall in the plurality of walls, attaching the at least one side edge of that wall to the at least one side edge of the at least one adjoining wall in the plurality of walls by at least one of i) heat sealing the at least one side edge of that wall to the at least one side edge of the at least one adjoining wall in the plurality of walls; ii) ultrasonically welding the at least one side edge of that wall to the at least one side edge of the at least one adjoining wall in the plurality of walls; and iii) laminating the at least one side edge of that wall to the at least one side edge of the at least one adjoining wall in the plurality of walls.

In some embodiments, attaching the peripheral portion of the synthetic resin fiber mesh cover to the remaining portion of the wall to cover the hole in the wall precedes forming the polybag out of the plurality of walls.

In accordance with an aspect of an embodiment of the present invention, there is provided a reinforced polybag, the reinforced polybag including i) a plurality of walls, each wall in the plurality of walls being made of a synthetic resin film and being attached along at least one side edge to at least one side edge of at least one adjoining wall in the plurality of walls, where at least one wall in the plurality of walls includes a hole in the wall and a remaining portion separating the hole in the wall from a side edge of the at least one side edge of the wall; and ii) a synthetic resin fiber mesh cover to cover the hole in the wall, a peripheral portion of the synthetic resin fiber mesh cover being attached to the remaining portion of the wall to cover the hole in the wall.

In some embodiments, i) the at least one side edge of the wall includes a plurality of side edges of the wall; and ii) the remaining portion of the wall separates the hole in the wall from each side edge of the plurality of side edges of the wall.

In some embodiments, i) the remaining portion of the wall includes an inner sub-portion adjacent the hole and an outer sub-portion between the inner sub-portion and the at least one side edge of the wall; and ii) the peripheral portion of the synthetic resin fiber mesh cover is attached to the inner sub-portion of the remaining portion of the wall, and an outer sub-portion of the remaining portion of the wall is uncovered by the synthetic resin fiber mesh cover.

In some embodiments, the reinforced polybag further includes indicia on the remaining portion of the wall.

In some embodiments, the reinforced polybag further includes indicia on the outer sub-portion of the remaining portion of the wall.

In some embodiments, the peripheral portion of the synthetic resin fiber mesh cover is heat-sealed to the inner sub-portion of the remaining portion of the wall.

In some embodiments, the peripheral portion of the synthetic resin fiber mesh cover is ultrasonically welded to the inner sub-portion of the remaining portion of the wall.

In some embodiments, the peripheral portion of the synthetic resin fiber mesh cover is laminated to the inner sub-portion of the remaining portion of the wall.

In some embodiments, for each wall in the plurality of walls, the at least one side edge of that wall is attached to the at least one side edge of the at least one adjoining wall in the plurality of walls, by at least one of i) heat sealing, ii) ultrasonic welding, and iii) lamination.

In some embodiments, the synthetic resin film includes at least one of polyethylene (PE), liner low density polyethylene (LLDPE), cast polypropylene (CPP), biaxially oriented polypropylene (BOPP), polyethylene terephthalate (PET) and nylon.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1A shows a perspective view of a reinforced polybag with a mesh window, in accordance with an embodiment of the invention;

FIG. 1B shows the reinforced polybag of FIG. 1A with a synthetic resin fiber mesh cover removed;

FIG. 1C shows a front elevation view of the reinforced polybag of FIG. 1A;

FIG. 1D shows a rear elevation view of the reinforced polybag of FIG. 1A;

FIG. 1E shows a top view of the reinforced polybag of FIG. 1A;

FIG. 2 shows a perspective view of a reinforced polybag with a mesh window, in accordance with an alternative embodiment of the invention;

FIG. 3A shows a perspective view of a reinforced polybag with a mesh window, in accordance with another embodiment of the invention;

FIG. 3B shows the reinforced polybag of FIG. 3A with a synthetic resin fiber mesh cover removed;

FIG. 3C shows a front elevation view of the reinforced polybag of FIG. 3A;

FIG. 3D shows a rear elevation view of the reinforced polybag of FIG. 3A;

FIG. 3E shows an enlarged view of a portion of the reinforced polybag of FIG. 3C taken at encircled section 3e;

FIG. 4A shows a perspective view of a reinforced polybag with a mesh window, in accordance with still another embodiment of the invention;

FIG. 4B shows the reinforced polybag of FIG. 4A with a synthetic resin fiber mesh cover removed;

FIG. 5 shows a flow chart of a method for making a reinforced polybag;

FIG. 6 shows a schematic illustration of a machine used in the manufacture of the reinforced polybags in accordance with an embodiment of the invention;

FIG. 7A shows a top view of the machine taken at the section 7a of FIG. 6;

FIG. 7B shows a top view of the machine taken at the section 7b of FIG. 6;

FIG. 7C shows a top view of the machine taken at the section 7c of FIG. 6;

FIG. 7D shows a top view of the machine taken at the section 7d of FIG. 6;

FIG. 8A shows side elevation view of a length of synthetic resin film;

FIG. 8B shows a side elevation view of a length of synthetic resin film after being processed by the machine of FIG. 6, in accordance with an embodiment of the invention; and

FIG. 9 shows a side elevation of a length of synthetic resin film after being processed by the machine of FIG. 6, in accordance with an alternative embodiment of the invention.

### DETAILED DESCRIPTION

The embodiments illustrated and described herein provide individual, non-limiting, examples in which the principles of the present invention are employed. It is possible to make other embodiments that employ the principles of the invention and that fall within the following claims. To the extent that the features of those examples are not mutually exclusive of each other, the features of the various embodiments may be mixed-and-matched, i.e., combined, in such manner as may be appropriate, without having to resort to repetitive description of those features in respect of each possible combination or permutation. The invention is not limited to the specific examples or details, which are given by way of illustration herein, but only by the claims, as mandated by law. The claims are to be given the benefit of purposive interpretation to include equivalents under the doctrine of equivalents.

In the description, like parts are marked throughout the specification and the drawings with the same respective reference numerals. The wording used herein is intended to include both singular and plural where such would be understood, and to include synonyms or analogous terminology to the terminology used, and to include equivalents thereof in English or in any language into which this specification may be translated, without being limited to specific words or phrases.

Mesh bags are frequently used for storing produce because they are considerably stronger than polybags made of resin film. The open structure of the mesh has the added advantage of providing the produce with access to fresh air, which can extend the shelf life of the produce. However, mesh bags are considerably more expensive than polybags. Additionally, it can be more difficult and expensive to print designs and text (“indicia”) on mesh, and may even in some instances be impossible to do so using printing techniques commonly used to print indicia on resin film. Even if indicia can be provided on the mesh, the result may be aesthetically inferior relative to indicia provided to the resin film. As a result, the mesh bags may be less suitable to provide printed product or brand information useful in selling and marketing the product without additional labels being attached.

An alternative to providing bags made entirely of mesh or entirely of resin film is to provide a bag that has one side made of mesh, and the other side made of resin film. This alternative in often referred to as the “half-and-half bag”. The half-and-half bag reduces material costs relative to a bag made entirely of mesh. However, it can also reduce the structural integrity of the half-and-half bag as the aggregate joined area at the seams of the mesh and resin film can be relatively small due to the open structure of the mesh. With these seams located at the side edges, the half-and-half bag can suffer from weak edges prone to splitting when the bag is supporting a heavy load. To improve the structural integrity of the half-and-half bag, the side edges of the bag can be formed by sealing a side edge made of the mesh and a side edge made of the resin film over a considerable area to increase the aggregate joined area, strengthening the seal. This can reduce the volume of the bag, or alternatively, add material costs to preserve the volume of the bag.

Another alternative to improve the structural integrity of the half-and-half bag is for the seam between the film and the mesh to be spaced upwardly from the bottom of the bag. This can involve providing a resin film wall that extends the entire length of a completed bag and, in addition, has a further downward extension. When the bag is assembled, the downward extension can be folded upwardly against an outer surface of a mesh wall. The folded extension and the mesh wall can be joined together at a seam spaced upwardly from the bottom portion of the folded extension. As a result, the bag has a bottom edge that no longer contains the seal between the resin film wall and the mesh wall. However, the remaining seams between the mesh wall and the resin film wall may remain located along the other side edges of the bag and prone to splitting under heavy loads.

Different aspects of different embodiments of the present invention comprise a reinforced polybag with a mesh window and a method of making the same. The reinforced polybag may include a plurality of walls. Each wall in the plurality of walls may be made of a synthetic resin film. Each wall in the plurality of walls can be attached along at least one side edge to at least one side edge of at least one adjoining wall in the plurality of walls. At least one wall in the plurality of walls can include a hole in the wall and a remaining portion separating the hole in the wall from a side edge of the at least one side edge of the wall. The reinforced polybag can further include a synthetic resin fiber mesh cover to cover the hole in the wall. A mesh window can be formed on the reinforced polybag by attaching a peripheral portion of the synthetic resin fiber mesh cover to the remaining portion of the wall to cover the hole in the wall. Since the synthetic resin fiber mesh cover can cover the hole in the wall, less synthetic resin fiber mesh can be used in contrast to known polybags in which an entire wall is synthetic resin fiber mesh. As a result, the reinforced polybag may provide a reduction in material costs and preserve real estate for printed advertising and product information, while also preserving the structural integrity of the reinforced polybag by separating the film-to-mesh attachment from at least one side edge of the reinforced polybag.

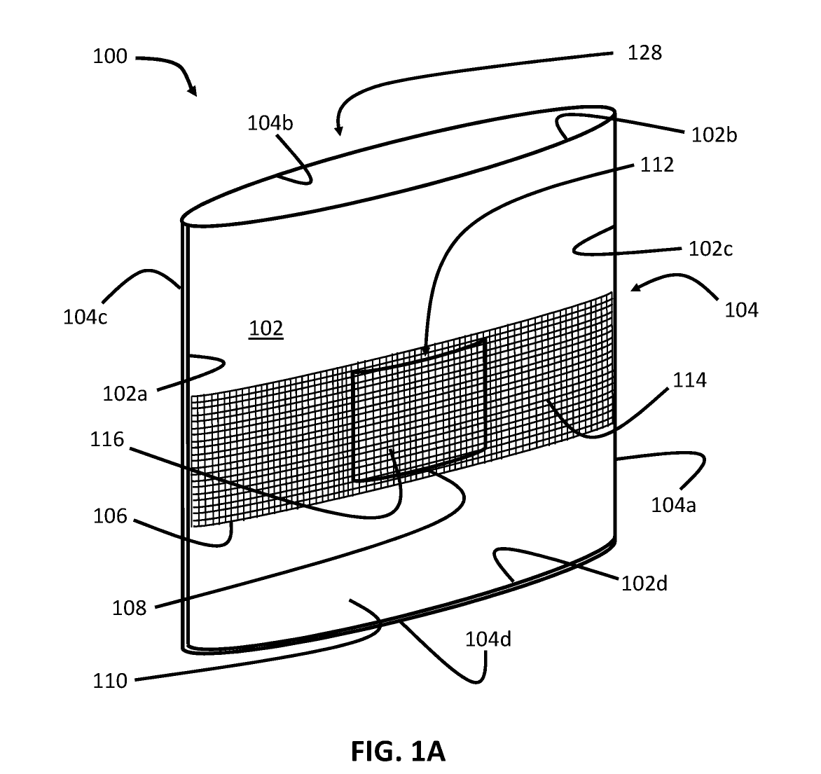

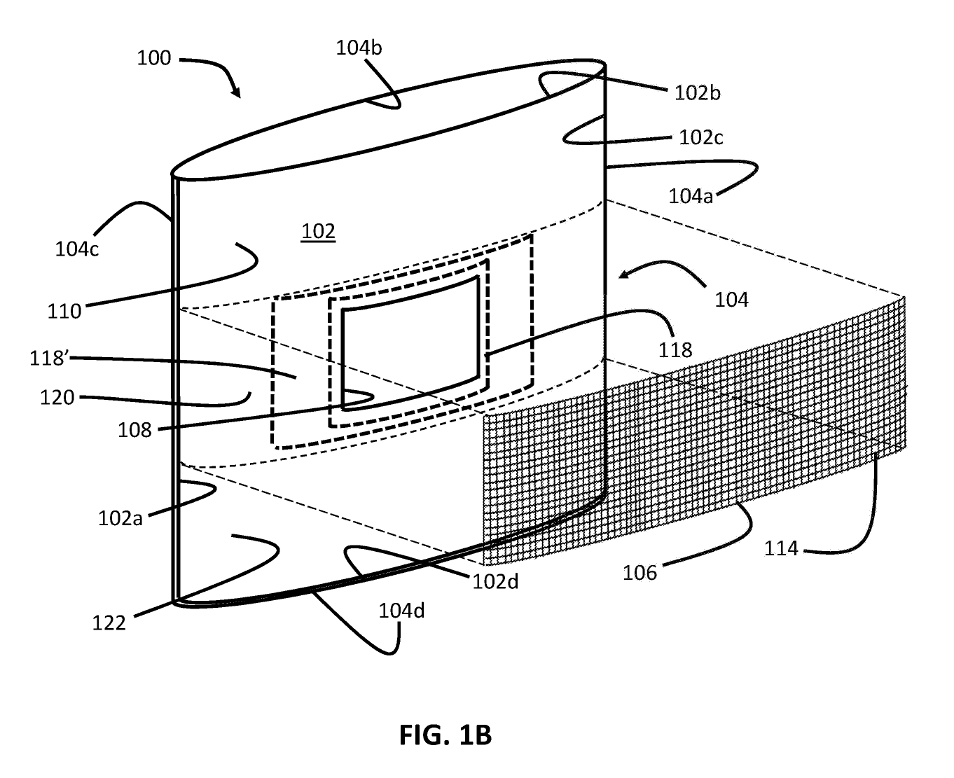

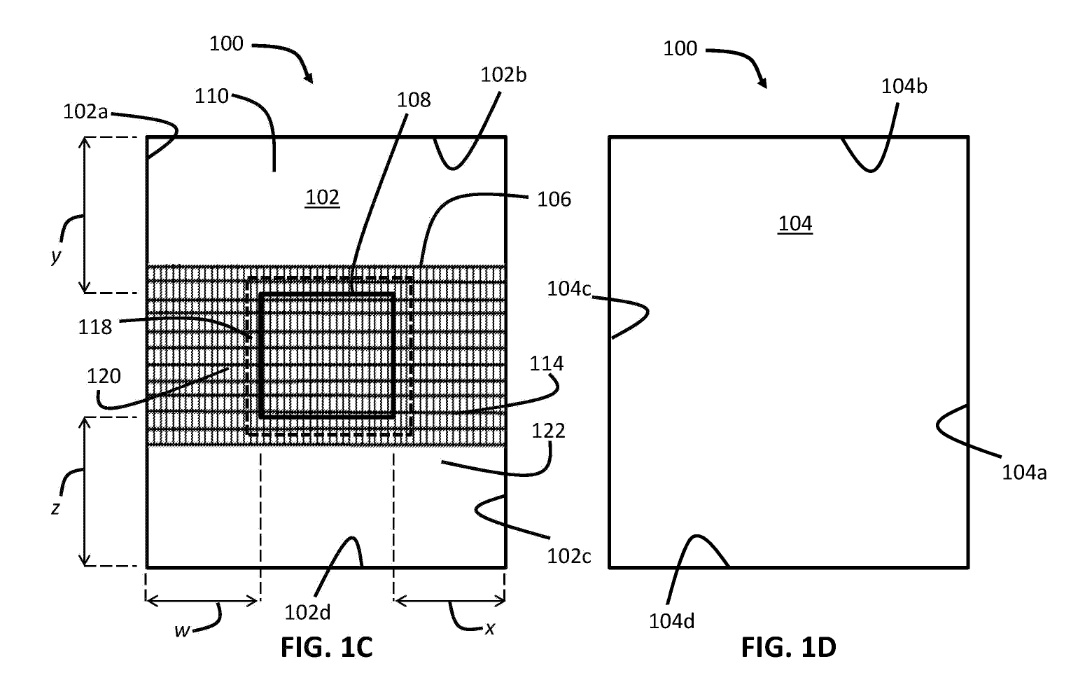

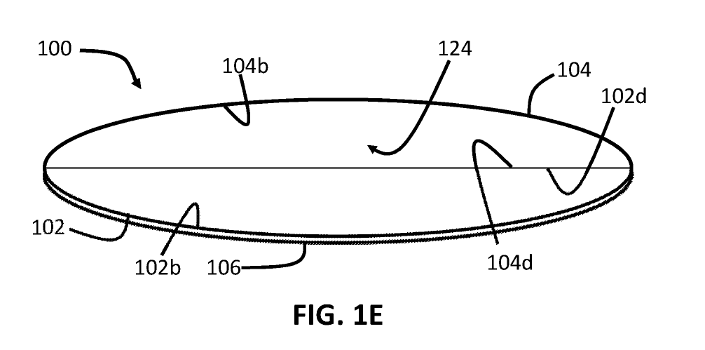

Reference is now made to FIG. 1A to illustrate an example reinforced polybag in accordance with an embodiment of the invention. FIG. 1A shows a perspective view of a reinforced polybag 100 having a first wall 102, a second wall 104, and a synthetic resin fiber mesh cover 106. The first wall 102 can be defined by a first side edge 102a, a second side edge 102b, a third side edge 102c, and a fourth side edge 102d, the first side edge 102a opposite the third side edge 102c and the second side edge 102b opposite the fourth side edge 102d. The second wall 104 can be defined by a first side edge 104a, a second side edge 104b, a third side edge 104c and a fourth side edge 104d, the first side edge 104a opposite the third side edge 104c and the second side edge 104b opposite the fourth side edge 104d. In the reinforced polybag 100 shown, the first side edge 102a, the third side edge 102c and the fourth side edge 102d of the first wall 102 are attached to the third side edge 104c, the first side edge 104a, and the fourth side edge 104d of the second wall 104, respectively. Although the reinforced polybag 100 of FIG. 1A has two walls (the first wall 102 and the second wall 104), alternative embodiments (not shown) may have more than two walls without departing from the principles of the invention. For example, an alternative embodiment of the reinforced polybag 100 may have three walls. In another alternative embodiment, the reinforced polybag 100 may have five walls. In yet another alternative embodiment, the reinforced polybag 100 may have seven walls.

The first wall 102 and the second wall 104 may be made of a synthetic resin film. For example, the synthetic resin may be polyethylene (PE), liner low density polyethylene (LLDPE), cast polypropylene (CPP), biaxially oriented polypropylene (BOPP), polyethylene terephthalate (PET) or nylon. The material selection of the synthetic resin film can be determined based on the intended use of the reinforced polybag 100, in association with the cost of each material. In FIG. 1, the first wall 102 and the second wall 104 of reinforced polybag 100 are shown to be rectangular-shaped. In alternative embodiments (not shown), the first wall 102 and second wall 104 may be another two-dimensional shape, such as a triangle or a square. Notwithstanding that other embodiments are possible, it may be convenient for the first wall 102 and the second wall 104 to be of similar shape and size for efficient use of material and ease of manufacturing.

Referring still to FIG. 1A, the first wall 102 can include a hole 108 and an external remaining portion 110. In the reinforced polybag 100, the external remaining portion 110 is shown separating the hole 108 from the first side edge 102a, the second side edge 102b, the third side edge 102c and the fourth side edge 102d of the first wall 102. A mesh window 112 can be provided on the first wall 102 of the reinforced polybag 100 by attaching a peripheral portion 114 of the synthetic resin fiber mesh cover 106 to the external remaining portion 110 of the first wall 102 to cover the hole 108.

Openings 116 in the mesh window 114 can allow fresh air to pass into reinforced polybag 100 through the hole 108 in the first wall 102, and may also allow gases emitted from the produce to escape the reinforced polybag 100. As described above, this can be especially important in preserving the shelf life of the produce stored in the reinforced polybag 100. As shown, the hole 108 can be sized such that it is smaller than the first wall 102. The size of the hole 108 can be determined based on the intended use of the reinforced polybag 100 and, in particular, the amount of fresh air flow needed to preserve to shelf life of the produce stored in the reinforced polybag 100. It may be the case that a sufficient amount of fresh air flow can be attained even when the hole 108 is only a small sub-portion of the first wall 102. As a result, the size of the synthetic resin mesh cover 106 needed to cover the hole 108 can also be reduced accordingly.

Although the reinforced polybag 100 of FIG. 1A shows the first wall 102 including the mesh window 112, alternative embodiments (not shown) can have the second wall 104 include an additional mesh window. This alternative embodiment may be convenient if the contents of the reinforced polybag 100 require additional access to fresh air to prolong their shelf life.

To form the reinforced polybag 100 of FIG. 1A, the first wall 102 and the second wall 104 can be adjoined by attaching at least two of the side edges 102a, 102c, 102d of the first wall 102 with at least two of the side edges 104c, 104a, 104d of the second wall 104, respectively. A third attachment may not be necessary if the plurality of walls can be folded to form the reinforced polybag 100. For example, fourth side wall 102d of the first wall 102 and the fourth side wall 104d of the second wall 104 can be adjoined by first folding the plurality of walls lengthwise before other attachments are made. The attachments between side edges of the first and the second walls 102, 104 can be made by any suitable method for attaching edges of synthetic resin film together. In a preferred embodiment, these attachments can be made by one of heat sealing, ultrasonic welding, and laminating. Heat sealing, ultrasonic welding and laminating can produce strong and durable bonds between adjoining edges of synthetic resin film. It may be convenient to provide the hole 108 in the first wall 102 before the polybag 100 is formed. Alternatively, it may be convenient to provide the hole 108 in the first wall 102 after the polybag 100 has been formed.

FIG. 1B shows the reinforced polybag 100 of FIG. 1A with the synthetic resin fiber mesh cover 106 removed. The synthetic resin fiber mesh cover 106 of the reinforced polybag 100 is sized such that the when the synthetic resin fiber mesh cover 106 is aligned to cover the hole 108 in the first wall 102, the peripheral portion 114 of the synthetic resin mesh cover 106 can extend between the first side edge 102a and the third side edge 102c of the first wall 102.

The external remaining portion 110 of the first wall 102 can include an inner-sub portion 120 adjacent to the hole 108 and an outer sub-portion 122 between the inner sub-portion 120 and the side edges 102b, 102d of the first wall 102. The peripheral portion 114 of the of the synthetic resin fiber mesh cover 106 can be attached to the inner sub-portion 120 of the external remaining portion 110 of the first wall 102. For example, the peripheral portion 114 can be attached at an attachment region 118 within the inner sub-portion 120 without being attached to other portions of inner sub-portion 120. As shown, the attachment region 118 may extend all the way around the perimeter of hole 108. That is, attaching the synthetic resin fiber mesh cover 106 to the attachment region 118 can close the hole 108, preventing produce (or other contents) from falling out. To strengthen the attachment between the peripheral portion 114 of the synthetic resin fiber mesh cover 106 and the inner sub-portion 120 of the external remaining portion 110, the attachment region 118 can be expanded to an attachment region 118′. The attachment region 118′ can provide for a larger aggregate joining area between the mesh of the peripheral portion 114 and the resin film of the inner sub-portion 120. In an alternative embodiment (not shown), an attachment region may be sized such that it is substantially all of the inner sub-portion 120 of the external remaining wall 110. This would further increase the aggregate joining area between the mesh of the peripheral portion 114 and the resin film of the inner sub-portion 120, but may also increase material costs.

In the example shown, the peripheral portion 114 can also be attached to the reinforced polybag 100 between the attachment of the side walls 102a and 104c and the side walls 102c and 104a, respectively. This additional attachment is non-essential in the structural integrity of the reinforced polybag 100; however, it can prevent the peripheral portion 114 of the synthetic resin cover 106 that is outside of the attachment region 118 (or 118′) from hanging loosely off the reinforced polybag 100.

Accordingly, the outer sub-portion 122 of the external remaining portion 110 of the first wall 102 can remain uncovered by the synthetic resin fiber mesh cover 106. As synthetic resin fiber mesh is more expensive than synthetic resin film, this can reduce material costs relative to other known polybags that use more synthetic resin fiber mesh for a polybag of similar size.

Referring still to FIG. 1B, the peripheral portion 114 of the synthetic resin fiber mesh cover 106 can be attached at the attachment region 118 (or 118′) of the inner sub-portion 120 of the external remaining portion 110 by any suitable method. In a preferred embodiment, the peripheral portion 114 of the synthetic resin fiber mesh cover 106 can be heat-sealed to the attachment region 118 (or 118′) of the inner sub-portion 120. In an alternative embodiment, the peripheral portion 114 of the synthetic resin fiber mesh cover 106 can be ultrasonically welded to the attachment region 118 (or 118′) of the inner sub-portion 120. In another alternative embodiment, the peripheral portion 114 of the synthetic resin fiber mesh cover 106 can be laminated to the attachment region 118 (or 118′) of the inner sub-portion 120.

Referring to FIG. 1C, illustrated therein is a front elevation view of the reinforced polybag 100 of FIG. 1A showing the outer sub-portion 122 of the external remaining portion 110 of the first wall 102. As described above, while the peripheral portion 114 of the synthetic resin fiber mesh cover 106 is attached to the inner sub-portion 120 of the external remaining portion 110 of the first wall 102, the outer sub-portion 122 can remain uncovered by the synthetic resin fiber mesh cover 106. The outer sub-portion 122 of the external remaining portion 110 of the first wall 102 can include indicia (not shown). As the outer sub-portion 122 of the external remaining portion 110 of the first wall 102 can be made of synthetic resin film, printing techniques commonly used to print indicia on synthetic resin film may be used to print indicia on the synthetic resin film. The indicia printed upon the outer sub-portion 122 can display a variety of product and brand information that can be useful in selling and marketing the product. The outer sub-portion 122 can provide additional space to display product and brand information relative to polybags with mesh surfaces lacking this outer sub-portion 122.

Referring still to FIG. 1C, the hole 108 can be centered in the first wall 102 such that a distance w from the first side edge 102a to the perimeter the hole 108 is substantially equal to a distance x from the third side edge 102c to the perimeter of the hole 108 and a distance y from the second side edge 102b to the perimeter of the hole 108 is substantially equal to a distance z from the fourth side edge 102d to the perimeter of the hole 108. With the hole 108 centered in the first wall 102, the film-to-mesh attachment between the peripheral portion 114 of the synthetic resin mesh cover 106 and the attachment region 118 (or 118′) of the inner sub-portion 120 of the external remaining portion 110 can be optimally spaced away from the side edges 102a, 102b, 102c and 102d of the first wall 102. This can lessen the likelihood that the attachment between the peripheral portion 114 of synthetic resin fiber mesh cover 106 and the attachment region 118 of the inner sub-portion 120 of the external remaining portion 110 splits or comes apart in a reinforced polybag carrying a heavy load. Notwithstanding that the centralized position of the hole 108 in the first wall 102 may be preferred, many other, non-centralized, positions of the hole 108 can be provided in the first wall 102.

As described above, due to their superior strength, film-to-film connections can be better suited than film-to-mesh connections to withstand the stresses placed on the side edges of adjoining walls of the reinforced polybag 100. As the side edges 102a, 102c and 102d of the first wall 102 can be attached to the side edges 104c, 104a, 104d of the second wall 104, respectively, entirely by a film-to-film connection, the reinforced polybags 100 can avoid the structural integrity issues that can be associated when film-to-mesh connections are used in the attachment of side edges of adjoining walls.

Referring to FIG. 1D, illustrated therein is a rear elevation view of the reinforced polybag 100 of FIG. 1A showing the second wall 104. As the second wall 104 can be made entirely of synthetic resin film, the second wall 104 can include indicia (not shown) across its entire external surface. As described above, the indicia can be printed using printing techniques commonly used to print indicia on synthetic resin film. Similar to the indicia displayed on the outer sub-portion 122 of the external remaining portion 110 of the first wall 102, the indicia displayed on the second wall 104 can include a variety of product and brand information that can be useful in selling and marketing the product.

Referring to FIG. 1E, illustrated therein is a top view of the reinforced polybag 100 of FIG. 1A showing a top end 124 in an open condition. When in the open condition, contents, such as produce, can be loaded into the reinforced polybag 100 from the top end 124. After the reinforced polybag 100 is filled, the top end 124 may be closed using, for example, a twist tie, a bread clip, tying a knot, a zip fastener, or another suitable means. Alternatively, the top end 124 may be closed by attaching the second side edge 102b of the first wall 102 and the second side edge 104b of the second wall 104 by one of heat sealing, ultrasonic welding and laminating. Alternatively, the top end 124 of the reinforced polybag 100 can be left open to provide easy access to the contents in the reinforced polybag 100 from the top end 124.

In an alternative embodiment (not shown), the top end 124 can be closed by attaching first wall 102 and the second wall 104 along an edge spaced a distance from the second side edge 102b of the first wall 102 and the second side edge 104c of the second wall 104. In this alternative embodiment, a handle can be formed by providing a hole between the edge and the second side edge 102b of the first wall 102 and a corresponding hole between the edge and the second side edge 104c of the second wall 104. This alternative embodiment may also contain an additional attachment along the second side edge 102b of the first wall 102 and the second side edge 104c of the second wall 104 to strengthen the handle. In further alternative embodiments (not shown), it may be convenient to provide a handle at different locations on the reinforced polybag 100.

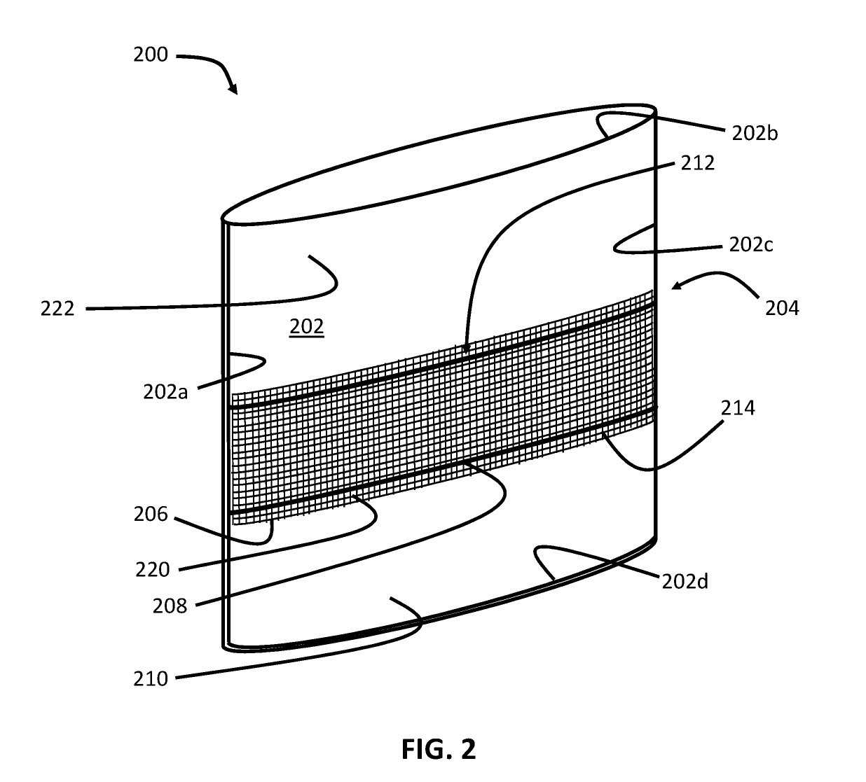

FIG. 2 illustrates a reinforced polybag in accordance with an alternative embodiment. FIG. 2 shows a perspective view of a reinforced polybag 200 having a first wall 202, a second wall 204, and a synthetic resin fiber mesh cover 206. In contrast to the reinforced polybag 100 of FIG. 1A, the first wall 202 of the reinforced polybag 200 includes an enlarged hole 208. The enlarged hole 208 can extend laterally between a first side wall 202a and a third side wall 202c of the first wall 202. In this way, an external remaining portion 210 can separate the enlarged hole 208 from a second side edge 202b and a fourth side edge 202d of the first wall 202. The external remaining portion 210 of the first wall 202 can include an inner-sub portion 220 adjacent to the hole 208 and an outer sub-portion 222 between the inner sub-portion 220 and the side edges 202b, 202d of the first wall 202. Similar to the reinforced polybag 100 of FIG. 1A, a mesh window 212 can be provided on the first wall 202 of the reinforced polybag 100 by attaching a peripheral portion 214 of the synthetic resin fiber mesh cover 206 to the inner sub-portion 220 of the external remaining portion 210 of the first wall 202 to cover the enlarged hole 208. As discussed above, the enlarged hole 208 may be necessary to allow a sufficient amount of air flow into and out of the reinforced polybag 200.

Although the hole 208 extends between the first side edge 202a and the third side edge 202c of the first wall 202, the hole 208 can remain separated from the fourth side wall 202d of the first wall 202. As a result, the film-to-mesh attachment between the peripheral portion 214 of the synthetic resin mesh cover 206 and the inner sub-portion 220 of the external remaining portion 210 can be spaced away from the fourth side edge 102d of the first wall 102. As a significant amount of the stress on the reinforced polybag 100, when loaded, may be placed along the fourth side edge 102d of the first wall 102 (i.e. the bottom of the reinforced polybag 200), this can lessen the likelihood that the attachment between the peripheral portion 114 of synthetic resin fiber mesh cover 106 and the inner sub-portion 120 of the external remaining portion 110 splits or comes apart.

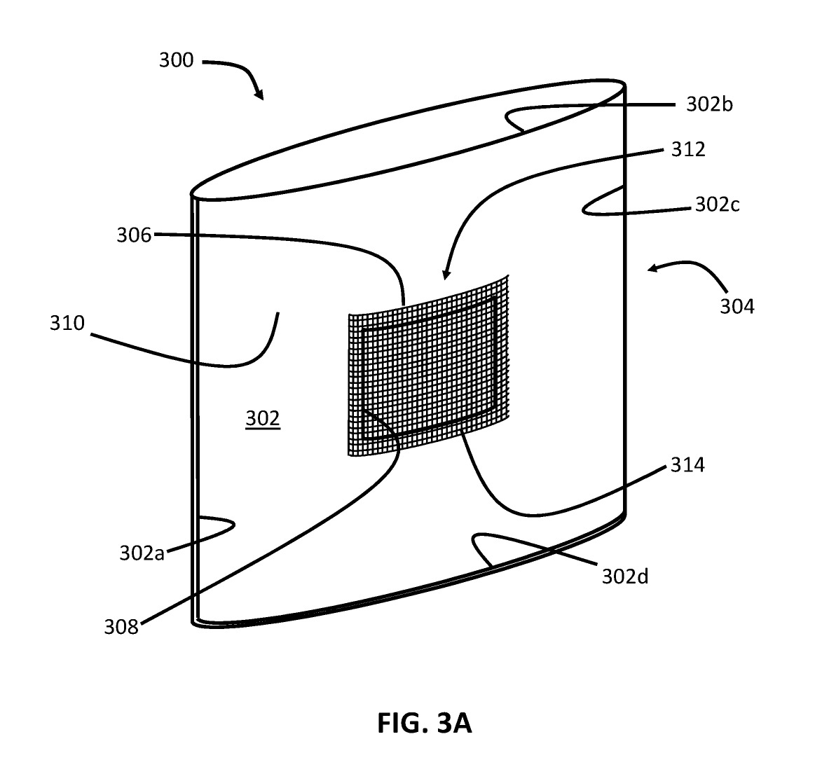

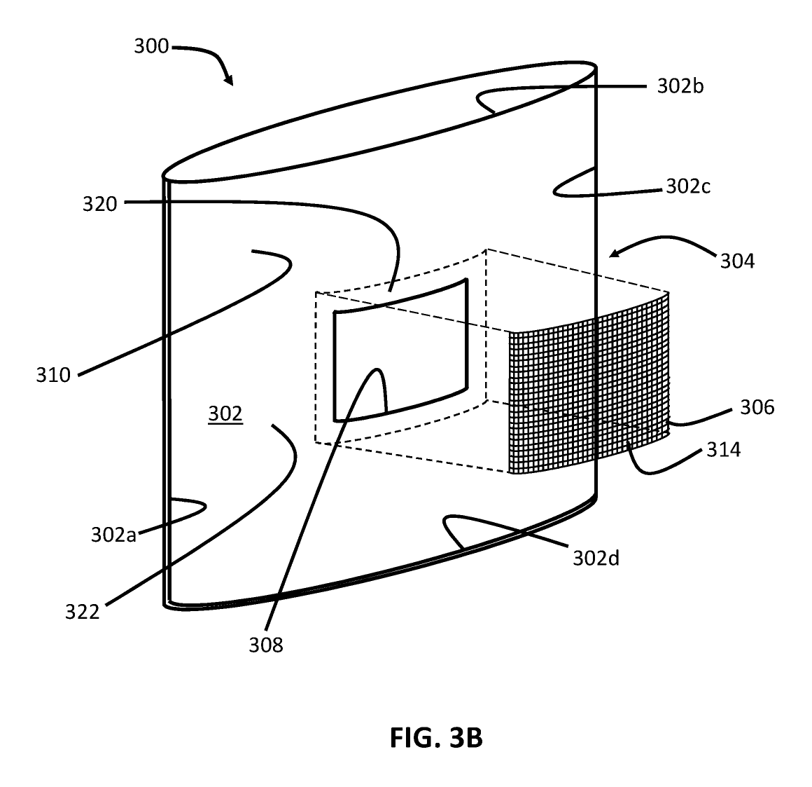

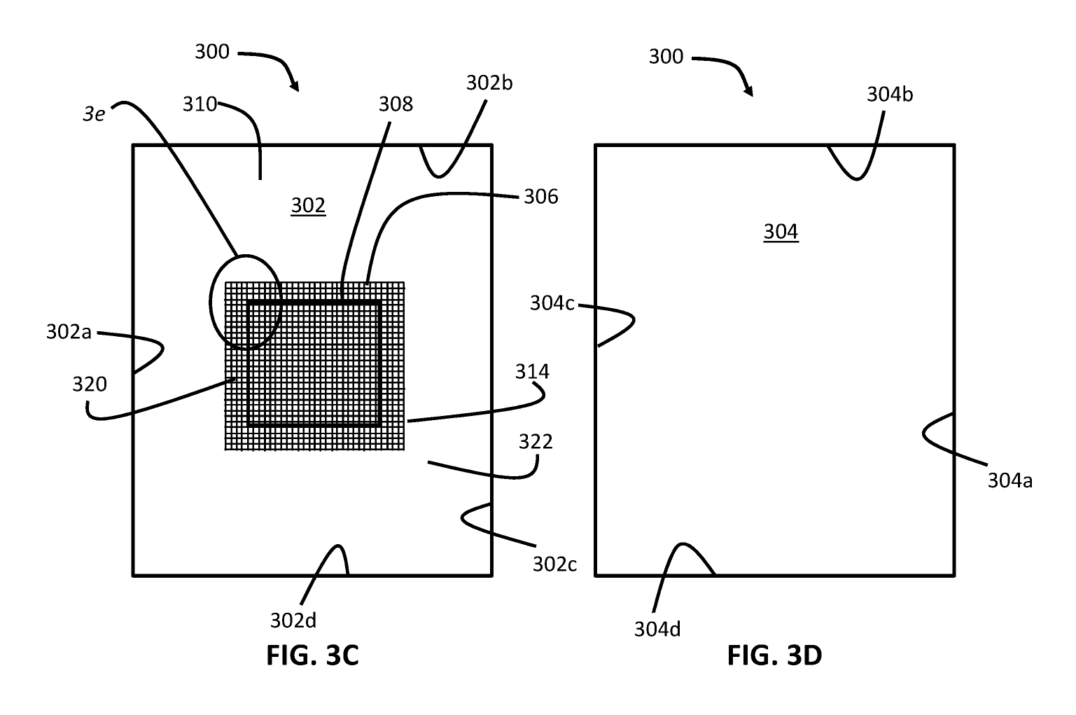

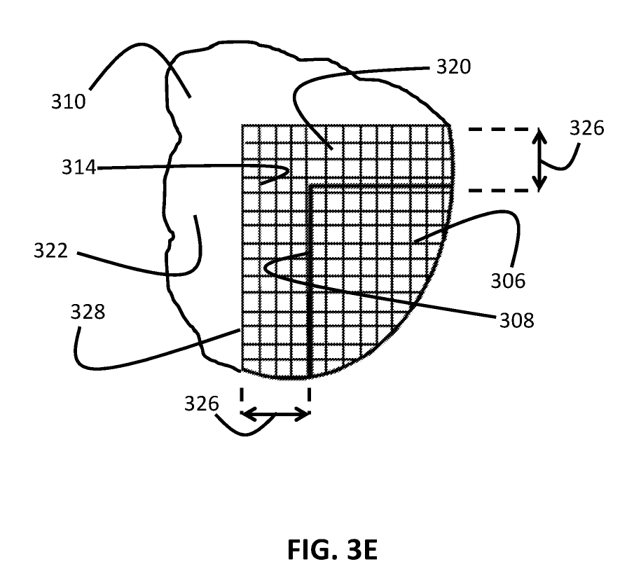

Reference is now made to FIG. 3A to illustrate an example reinforced polybag in accordance with another alternative embodiment. FIG. 3A shows a perspective view of a reinforced polybag 300 having a first wall 302, a second wall 304, and a synthetic resin fiber mesh cover 306. The reinforced polybag 100 of FIG. 1A and the reinforced polybag 300 are substantially similar except that the synthetic resin fiber mesh cover 306 of the reinforced polybag 300 is reduced in size relative to the synthetic resin mesh cover 106 of the reinforced polybag 100. The first wall 302 can include a hole 308 and an external remaining portion 310. In this way, the external remaining portion 310 can separate the hole 308 from the side edges 302a, 302b, 302c, 302d of the first wall 302. A mesh window 312 can be provided on the first wall 102 of the reinforced polybag 100 by attaching a peripheral portion 314 of the synthetic resin fiber mesh cover 306 to the external remaining portion 310 of the first wall 302 to cover the hole 308.

FIG. 3B shows the reinforced polybag 300 of FIG. 3A with the synthetic resin fiber mesh cover 306 removed. Similar to the reinforced polybag 100 of FIG. 1B, the synthetic resin fiber mesh cover 306 can be sized such that when the synthetic resin fiber mesh cover 306 is aligned with a hole 308 in the first wall 302, a peripheral portion 314 of the synthetic resin fiber mesh cover 306 can extend around the perimeter of the hole 308 and be attached to the external remaining portion 310 of the first wall 302. However, the synthetic resin fiber mesh cover 306 can be sized such that the peripheral portion 314 of the synthetic resin fiber mesh cover 306, when aligned with the hole 308, extends only slightly passed the perimeter of the hole 308. The external remaining portion 310 of the first wall 302 can include an inner-sub portion 320 adjacent to the perimeter of the hole 308 and an outer sub-portion 322 between the inner sub-portion 320 and side edges 302a, 302b, 302c, 302d of the first wall 302. The peripheral portion 314 of the of the synthetic resin fiber mesh cover 306 can be attached to the inner sub-portion 320 of the external remaining portion 310 of the first wall 302. Accordingly, the reinforced polybag 300 can provide even further material savings by minimizing the amount of synthetic resin fiber mesh needed.

Referring still to FIG. 3B, a strong and durable attachment between the peripheral portion 314 of the synthetic resin fiber mesh cover 306 and the inner sub-portion 320 of the external remaining portion 310 of the first wall 302 can be provided when the synthetic resin fiber mesh cover 306 is centrally aligned with the hole 308 in the first wall 302 such that the peripheral portion 314 is equally spaced around the perimeter of the hole 308. In alternative embodiments, the synthetic resin fiber mesh cover 306 can be aligned with the hole 108 such that the peripheral portion 314 of the synthetic resin fiber mesh cover 306 may not be equally spaced around the perimeter of the hole 308.

As described above, due to their superior strength, film-to-film connections can be better suited than film-to-mesh connections to withstand the stresses placed on the side edges of adjoining walls of the reinforced polybag 300. As the side edges 302a, 302c and 302d of the first wall 302 can be attached to the side edges 304c, 304a, 304d of the second wall 304, respectively, entirely by a film-to-film connection, the reinforced polybags 300 can avoid the structural integrity issues that can be associated when film-to-mesh connections are used in the attachment of side edges of adjoining walls.

Referring to FIG. 3C, illustrated therein is a front elevation view of the reinforced polybag 300 of FIG. 3A showing the outer sub-portion 322 of the external remaining portion 310 of the first wall 302. As described above, when the peripheral portion 314 of the synthetic resin fiber mesh cover 306 is attached to the inner sub-portion 320 of the external remaining portion 310 of the first wall 302, the outer sub-portion 322 can remain uncovered by the synthetic resin fiber mesh cover 306. In contrast to the synthetic resin fiber mesh covers 106 and 206 of FIGS. 1A and 2, respectively, the synthetic resin fiber mesh cover 306 of FIG. 3A can provide additional space to display the indicia on the reinforced polybag 300.

Referring to FIG. 3D, illustrated therein is a rear elevation view of the reinforced polybag 300 of FIG. 3A showing the second wall 304. As with the second wall 104 of the reinforced polybag 100 of FIG. 1D, the second wall 304 can be made entirely of synthetic resin film and, as a result, can include indicia (not shown) across its entire external surface printed using printing techniques commonly used to print indicia on synthetic resin film.

FIG. 3E shows an enlarged portion of the reinforced polybag 300 taken at section 3e of FIG. 3C. The strength of the attachment between the peripheral portion 314 of the synthetic resin fiber mesh cover 306 and the inner sub-portion 320 of the external remaining portion 310 of the first wall 302 can be varied by adjusting the size of the synthetic resin fiber mesh cover 306 relative to the size of the hole 308. Varying the size of the synthetic resin fiber mesh cover 306 relative to the size of the hole 108 can increase the area of the inner sub-portion 320 of the external remaining portion 110 of the first wall 302 when attached to the peripheral portion 314 of the synthetic resin fiber mesh cover 306. As the area of the inner sub-portion 320 is increased, an aggregate joining area 326 formed between the perimeter of the hole 308 and an outer periphery 328 of the synthetic resin fiber mesh cover 306 may correspondingly increase. The larger the aggregate joining area 326, the stronger the attachment, other things equal, between the peripheral portion 314 of the synthetic resin fiber mesh cover 306 and the inner sub-portion 320 of the external remaining portion 310 of the first wall 302. The size of the synthetic resin mesh fiber cover 306 relative to the size of the hole 308 can be determined based on the desired strength of the attachment, viewed in combination with the cost of materials.

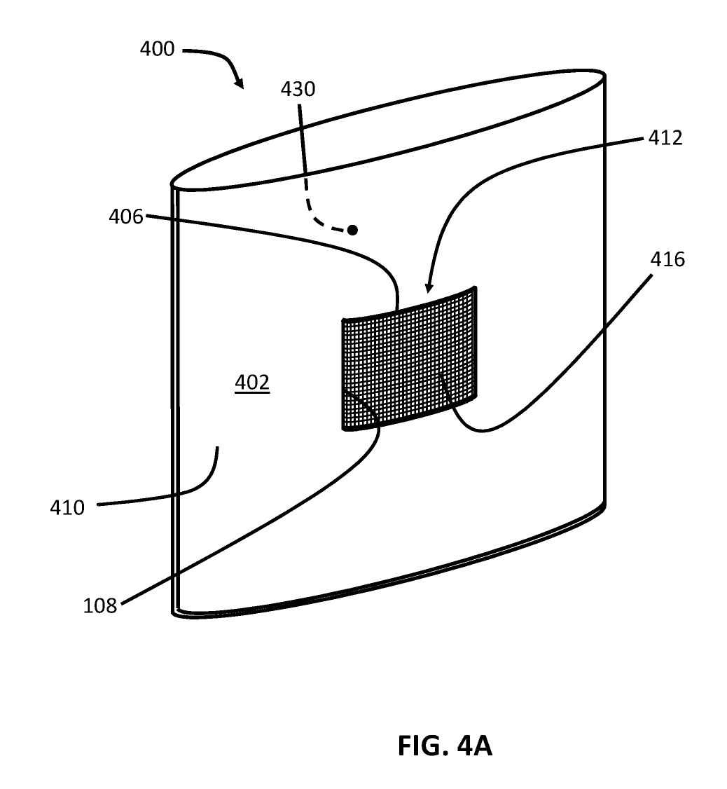

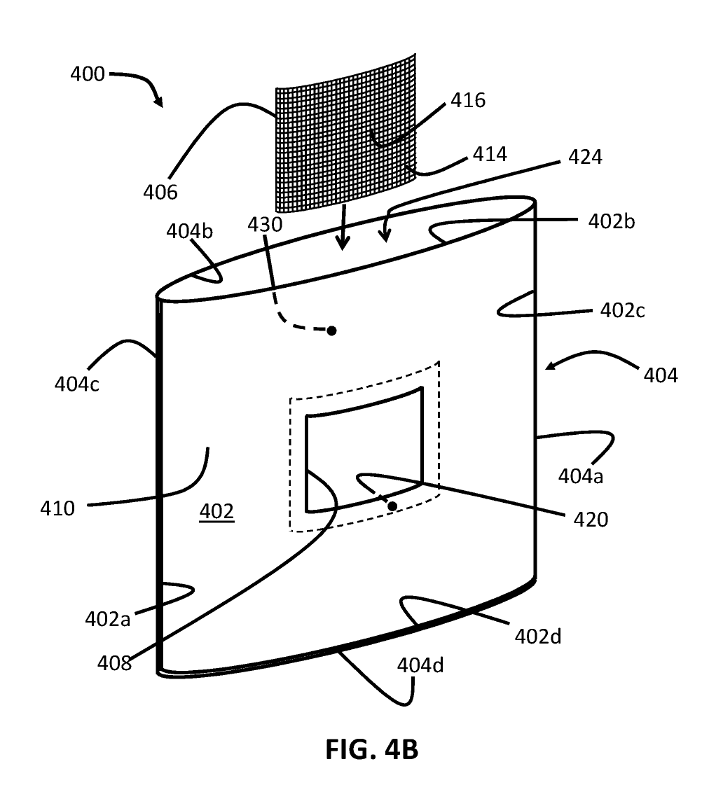

FIGS. 4A and 4B illustrate an alternative embodiment of the reinforced polybag 300 of FIG. 3A. FIG. 4A shows a reinforced polybag 400 having a mesh window 412 formed by attaching a synthetic resin fiber mesh cover 406 to an internal remaining portion 430 of a first wall 402. That is, the attachment between a peripheral portion 414 (FIG. 4B) of the synthetic resin fiber mesh cover 406 and the internal remaining portion 430 of the first wall 402 can be on the opposite side of the exterior of the reinforced polybag 400. As shown in FIG. 4B, the synthetic resin fiber mesh cover 406 can be inserted into the reinforced polybag 400 from an open end 424. The synthetic resin fiber mesh cover 406 can be aligned inside the reinforced polybag 400 such that the peripheral portion 416 can be attached to an inner sub-portion 420 of the internal remaining portion 430 of the first wall 402 to cover the hole 408. Alternatively, the reinforced polybag 400 of FIG. 4A can be provided by attaching the synthetic resin fiber mesh cover 406 to the inner sub-portion 420 of the internal remaining portion 422 of the first wall 402 prior to the side edges 402a, 402c, 402d of the first wall 402 being attached to the side edges 404c, 402a, 402d of the second wall 404, respectively. Alternatively, the reinforced polybag 400 shown in FIG. 4A can be provided by turning the reinforced polybag 300 of FIG. 3A inside-out.

As described above, techniques for printing indicia on synthetic resin film may not be suitable for printing indicia on synthetic resin fiber or mesh. Moreover, even if indicia can be printed on the synthetic resin fiber mesh, openings 416 in the synthetic resin fiber mesh cover 406 can prevent the indicia from being effectively displayed. When the attachment between the peripheral portion 414 of the synthetic resin fiber mesh cover 406 and the inner sub-portion 420 of the internal remaining portion 430 of the first wall 402 is on the inside, opposite to the exterior of the reinforced polybag 400, the external remaining portion 410 of the first wall 102 may no longer include the inner-sub portion 320 (as shown on FIG. 3B). In this way, the reinforced polybag 400 can include indicia across the entirety of the external remaining portion 410 of the first wall 402. That is, in contrast to the reinforced polybag 300 of FIG. 3A, the reinforced polybag 400 of FIG. 4A can provide additional space to display the indicia around the perimeter of the hole 408.

The reinforced polybags 100, 200, 300, 400 of FIGS. 1A, 2, 3A and 4A are shown having rectangular holes 108, 208, 308, 408 provided in the respective first walls 102, 202, 302, 402. In alternative embodiments, the holes 108, 208, 308, 408 can be one of any other two-dimensional shape. Similarly, the synthetic resin fiber mesh covers 106, 206, 306, 406 can be rectangular. In alternative embodiments, the synthetic resin fiber mesh covers 106, 206, 306, 406 can be one of any other two-dimensional shape. For example, the holes 108, 208, 308, 408 and the synthetic resin fiber mesh covers 106, 206, 306, 406 can each be one of circular, oval-shaped, triangular, square, or could be the shape of other regular or irregular polygons. Notwithstanding that there are many possible variations, it may be convenient for the shape of the holes 108, 208, 308, 408 to be consistent with the shape of the synthetic resin fiber mesh covers 106, 206, 306, 406 for the most efficient use of material.

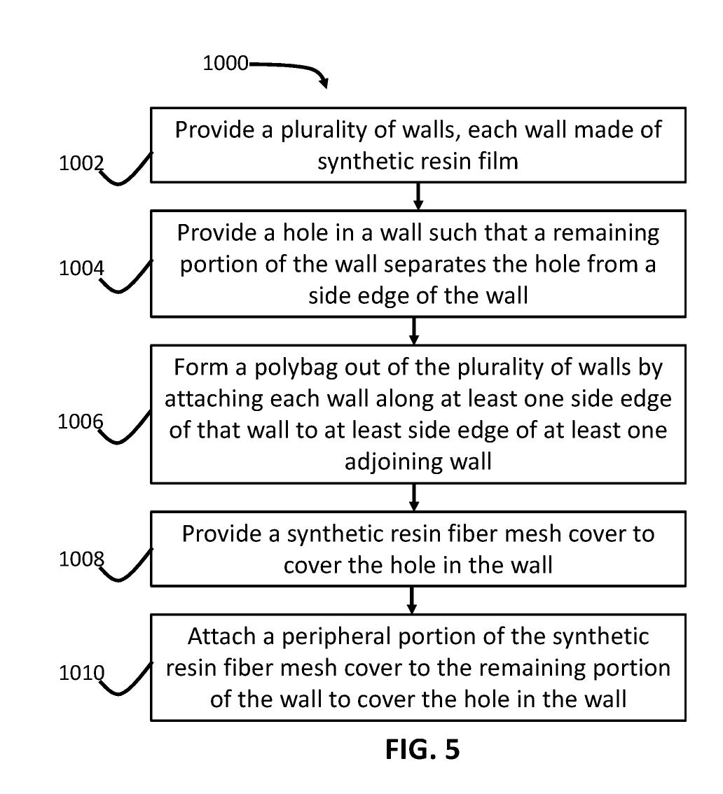

FIG. 5 shows a flow chart of a method 1000 for making the reinforced polybags 100, 200, 300 and 400. At 1002, a plurality of walls formable into the polybag can be provided. Each wall in the plurality of walls can be made of a synthetic resin film. Each wall in the plurality of walls is attachable along at least one side edge to at least one side edge of at least one adjoining wall in the plurality of walls. At 1004, a hole can be provided in a wall in the plurality of walls such that a remaining portion of the wall separates the hole in the wall from a side edge of the at least one side edge of the wall. At 1006, the polybag can be formed out of the plurality of walls by attaching each wall along the at least one side edge of that wall to the at least one side edge of the at least one adjoining wall. At 1008, a synthetic resin fiber mesh cover can be provided to cover the hole in the wall. At 1010, a peripheral portion of the synthetic resin fiber mesh cover can be attached to the remaining portion of the wall to cover the hole in the wall. For example, attaching the peripheral portion of the synthetic resin fiber mesh cover to the remaining portion of the wall can involve attaching the peripheral portion of the synthetic resin fiber mesh cover to an inner sub-portion of the remaining portion of the wall adjacent the perimeter of the hole, such that an outer sub-portion of the remaining portion of the wall remains uncovered by of the synthetic resin fiber mesh.

The at least one side edge of the wall can include a plurality of side edges of the wall. At 1004, providing the hole in the wall can include providing the hole in the wall such that the remaining portion of the wall separates the hole in the wall from each side edge of the plurality of sides of the wall (see e.g., the reinforced polybags 200, 300 and 400 of FIGS. 2, 3A and 4A, respectively).

For example, the method 1000 may further include providing indicia on the remaining portion of the wall (see e.g., the reinforced polybag 400 of FIG. 4A). In another example, the method 1000 may further include providing indicia on the outer sub-portion of the remaining portion of the wall (see e.g., the reinforced polybags 100, 200, and 300 of FIGS. 1A, 2 and 3A, respectively). The indicia, for example, may include product and brand information useful in the selling and marketing of the product within the reinforced polybag.

Referring still to FIG. 5, the method 1000 may further include providing a first die and a second die, distinct from the first die. For example, at 1004, providing the hole in the wall can further involve operating the first die to provide the hole in the wall. For example, at 1010, attaching the peripheral portion of the synthetic resin fiber mesh cover to the remaining portion of the wall to cover the hole in the wall can involve drawing the synthetic resin fiber mesh cover over the hole and then operating the second die to attach the peripheral portion of the synthetic resin fiber mesh cover to the remaining portion of the wall to cover the hole in the wall.

For example, at 1006, forming the polybag out of the plurality of walls can involve first cutting the plurality of walls and then, for each wall in the plurality of walls, attaching the at least one side edge of that wall to the at least one side edge of the at least one adjoining wall in the plurality of walls. In this example, the at least one side edge of that wall can be attached to the at least one side of the at least one adjoining wall by one of i) heat sealing, ii) ultrasonically welding, and iii) laminating.

For example, at 1010, attaching the peripheral portion of the synthetic resin fiber mesh cover to the remaining portion of the wall can involve heat-sealing the peripheral portion of the synthetic resin fiber mesh cover to the inner sub-portion of the remaining portion of the wall. In this example, the second die may be a heat sealing die dimensioned to heat seal around the hole in the wall.

In another example, at 1010, attaching the peripheral portion of the synthetic resin fiber mesh cover to the remaining portion of the wall can involve ultrasonically welding the peripheral portion of the synthetic resin fiber mesh cover to the inner sub-portion of the remaining portion of the wall. In this example, the second die may be an ultrasonic welding die dimensioned to ultrasonically weld around the hole in the wall.

In still another example, at 1010, attaching the peripheral portion of the synthetic resin fiber mesh cover to the remaining portion of the wall can involve laminating the peripheral portion of the synthetic resin fiber mesh cover to the inner sub-portion of the remaining portion of the wall. In this example, the second die may be a laminating die dimensioned to laminate around the hole in the wall.

For some aspects of the method 1000, it may be convenient to modify the order of the steps. For example, providing the hole in the wall in the plurality of walls may precede forming the polybag out of the plurality of walls by attaching each wall in the plurality of walls along the at least side edge to the at least one side edge of the at least one adjoining wall in the plurality of walls. In another example, attaching the peripheral portion of the synthetic resin fiber mesh cover to the remaining portion of the wall to cover the hole in the wall at 1010 may precede forming the polybag out of the plurality of walls at 1002.

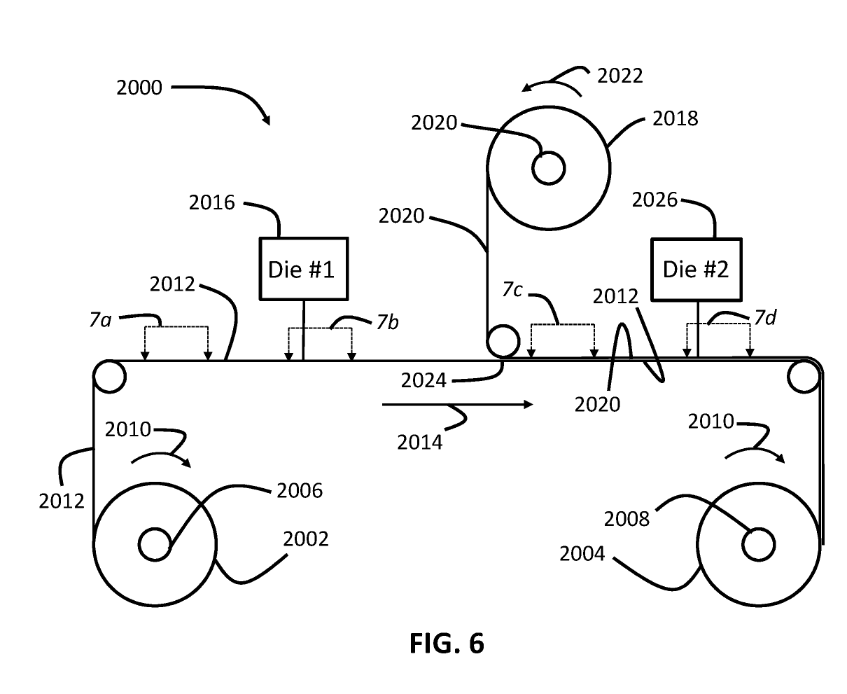

FIGS. 6, 7A-7D, 8A-8B and 9 are discussed below, to illustrate a method of making the reinforced polybag 100 of FIG. 1A-1E using a machine 2000 and a bag-converting machine (not shown). Although this discussion refers to the reinforced polybag 100, the method described below can apply to make the reinforced polybags 200, 300, and 400 of FIGS. 2, 3A and 4A, respectively, using the machine 2000 and bag-converting machine without departing from the principles of the invention.

FIG. 6 shows a schematic illustration of the machine 2000 used in making the reinforced polybag 100 (FIGS. 1A-1E). The machine 2000 includes a first spool 2002 and a second spool 2004 spaced laterally from the first spool 2002. The first spool 2002 can be rotated about a central axis 2006. Similarly, the second spool 2004 can be rotated about a central axis 2008. In the example shown, the first spool 2002 and the second spool 2004 are rotatable about the central axis 2006, 2008, respectively, in a clockwise direction 2010. The first spool 2002 can be loaded with a roll of a length of synthetic resin film 2012. Through the rotation of the first spool 2002 and the second spool 2004 in the clockwise direction 2010, the length of synthetic resin film 2012 can be unrolled from the first spool 2002 and then travel in a machine direction 2014 toward the second spool 2004. The first spool 2002 and the second spool 2004 are rotatable at the same rate for efficient operation of the machine 2000.

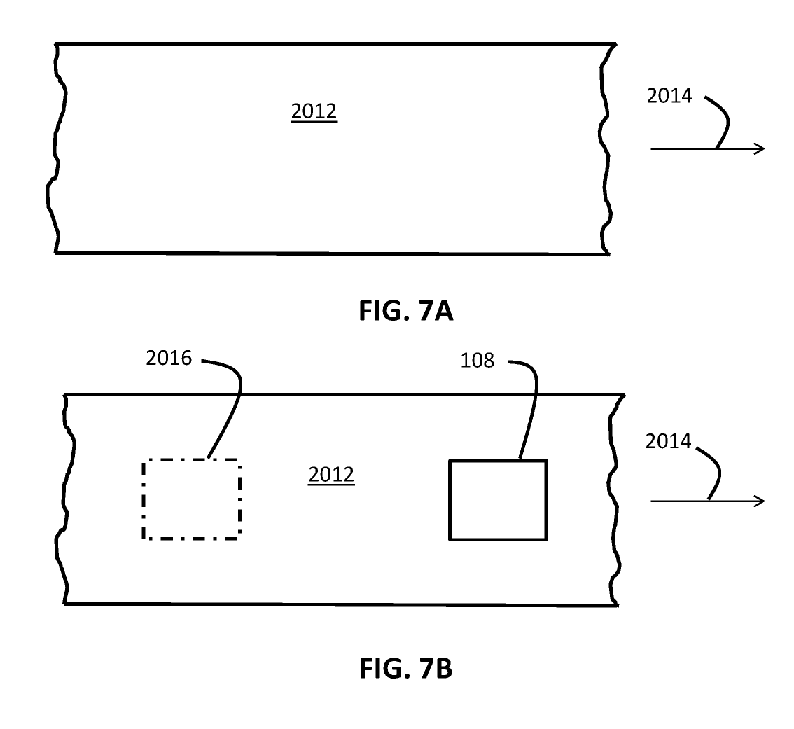

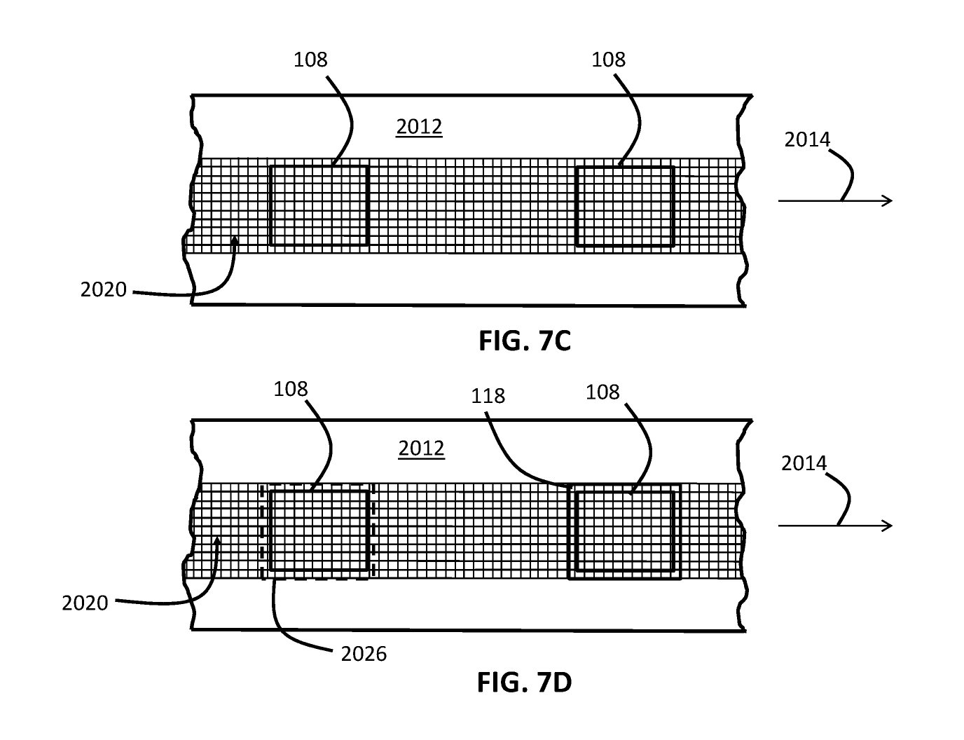

The machine 2000 further includes a first die 2016 positionable such that it can access the length of synthetic resin film 2012 as it travels between the first spool 2002 and the second spool 2004. In a preferred embodiment, the first die 2016 is a dinking die designed to cut the hole 108 (see e.g., FIG. 7B) in the passing length of synthetic resin film 2012. The size of the hole 108 cut can be adjusted by changing the size of the first die 2016. For example, different first dies 2016 can be used to cut holes 108 that are 4″×6″, 5″×8″, 6″×10″, etc. The first die 2016 can be automated such that it can cut holes 108 at a predefined time or after a predetermined length of synthetic resin 2012 has passed the first die 2016.

The machine 2000 further includes a third spool 2018 rotatable about a central axis 2020. The third spool 2018 can be spaced from the first spool 2002 and second spool 2004 in a direction substantially orthogonal to the machine direction 2014 and positioned downstream of the first die 2016 in the machine direction 2014. As shown in FIG. 6, the third spool 2018 can be above the first spool 2002 and the second spool 2004. In alternative embodiments of the machine 2000, the third spool 2018 may be below the first spool 2002 and the second spool 2004. The third spool 2018 can be loaded with a roll of a length of synthetic resin fiber mesh 2020. In the example shown, the third spool 2018 is rotatable in a counterclockwise direction 2022. In alternative embodiments (not shown), the third spool 2018 can be rotated in a clockwise rotation. Through the rotation of the third spool 2018 in the counterclockwise direction 2022, the length of synthetic resin fiber mesh 2020 can be unrolled and then travel in the direction orthogonal to the machine direction 2014 until it reaches the passing length of synthetic resin film 2012 at a contact region 2024. Since the third spool 2018 is positioned downstream of the first die in the machine direction 2014, the passing length of synthetic resin film 2012 has holes 108 previously cut (see e.g., FIG. 7C). Accordingly, the contact region 2024 can be aligned such that the holes 108 in the passing length of synthetic resin film 2012 can be overlaid and completely covered by the length of synthetic resin fiber mesh 2020. The length of synthetic resin film 2012 now overlaid with the length of synthetic resin fiber 2020 can travel together in the machine direction 2014.

The machine 2000 further includes a second die 2026 downstream of the third spool 2018 in the machine direction 2014 such that it can access the passing length of synthetic resin film 2012 previously overlaid with the synthetic resin fiber mesh 2020. The second die 2026 can be a sealing die designed to provide the attachment region 118 (see e.g., FIG. 7D) between the length of synthetic resin fiber mesh 2020 around the holes 2028 in the length of synthetic resin film 2012. In this way, the second die 2026 can be sized according to the size of the first die 2016. In a preferred embodiment, the second die 2026 is a heat sealing die and the attachment region 118 around the hole 108 is a heat seal. In an alternative embodiment, the second die 2026 may be a laminating die dimensioned to laminate around the holes 108 in the length of synthetic resin film 2012. In another alternative embodiment, the second die 2026 may be an ultrasonic welding die dimensioned to ultrasonically weld around the holes 108 in the length of synthetic resin film 2012. Similar to the first die 2016, the second die 2026 can be automated such that it can seal around the hole 108 in the length of synthetic resin film 2012 at a predefined time or after a predetermined length of synthetic resin film 2012 has passed the second die 2026. It may be convenient to operate the first die 2016 and the second die 2026 at the same rate for efficient operation of the machine 2000. It may be convenient for the third spool 2018 to rotate at the same rate as the first spool 2002 and the second spool 2004 for efficient operation of the machine 2000.

It may be convenient for the rotation of the first, second and third spools 2002, 2004, and 2018 to be automated such that they correspond to the operation of the first and second dies 2016, 2026. That is, the rotation (i.e. the machine direction 2014) may be automatically stopped when the first die 2016 is cutting a hole in the synthetic resin film 2012 and the second die 2026 is sealing a hole in the synthetic resin film 2012 downstream of the first die 2016 in the machine direction 2014.

Lastly, the length of the synthetic resin film 2012 with the length of synthetic resin fiber mesh 2020 sealed around the holes 108 in the synthetic resin film 2012 travels in the machine direction 2014 until reaching the second spool 2004 where it is collected (i.e. re-rolled). This roll of the synthetic resin film 2012 with the attached synthetic resin fiber mesh 2020 can then be removed from the third spool 2018 and provided to a bag-converting machine (not shown) to form a plurality of reinforced polybags.

FIGS. 7A to 7D illustrate intermediate steps in the method of making the reinforced polybag 100 (FIGS. 1A-1E) using the machine 2000. FIG. 7A shows a top view of synthetic resin film 2012 above the machine 2000 taken at section 7a of FIG. 6. FIG. 7B shows a top view of synthetic resin film 2012 above the machine 2000 taken at section 7b of FIG. 6. FIG. 7C shows a top view of synthetic resin film 2012 above the machine 2000 taken at section 7d of FIG. 6. FIG. 7D shows a top view of synthetic resin film 2012 above the machine 2000 taken at section 7d of FIG. 6.

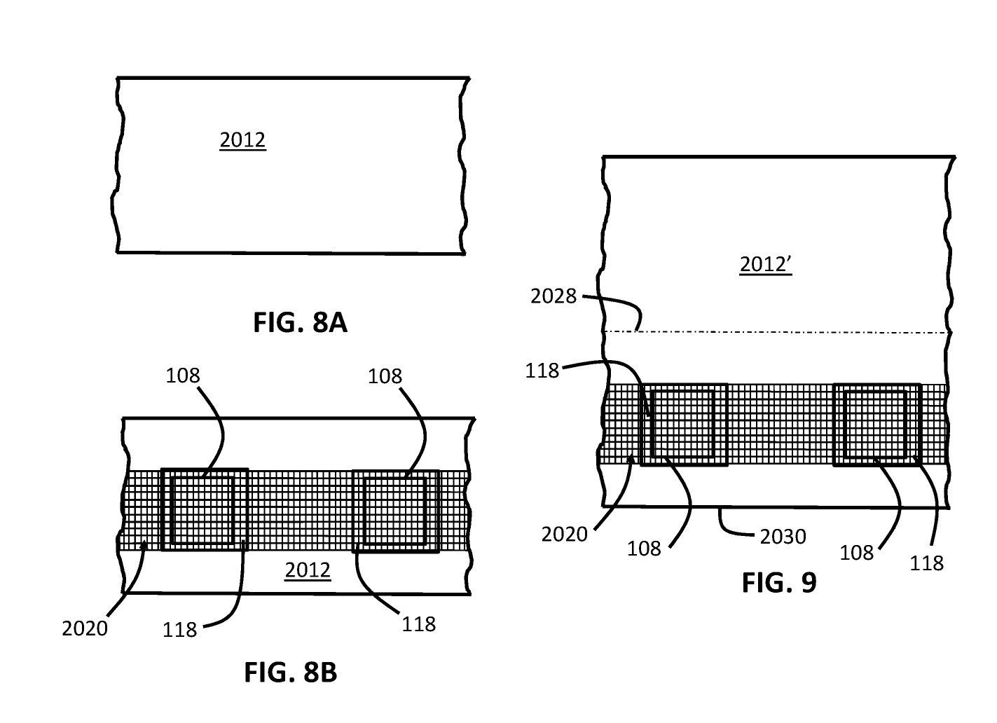

Reference is now made to FIGS. 8A-8B to describe an example of what material may be provided to the bag-converting machine to manufacture the reinforced polybag 100 (FIGS. 1A-1E). For example, the bag-converting machine can be provided with a first roll of material and a second roll of material. FIG. 8A shows a length of the first roll of material. As shown, the first roll of material can be the length of the synthetic resin film 2012 that has not been altered by the machine 2000. That is, the synthetic resin film 2012 has no holes formed therein and has no synthetic resin fiber mesh attached. FIG. 8B shows a length of the second roll of material. As shown, the second roll of material can be the length of the synthetic resin film 2012 collected at the second spool 2004 of the machine 2000. That is, the second roll of material can be the length of synthetic resin film 2012 having the length of synthetic resin fiber mesh 2020 sealed at the attachment regions 118 around the holes 108 in the synthetic resin film 2012. The bag-converting machine can then cut the first roll of material and the second roll of material into a plurality of walls. The bag-converting machine can be adjusted to cut walls of a variety of sizes depending on the intended use of the reinforced polybag 100. For example, the bag-converting machine can cut the first wall 102 (see e.g., FIG. 1A) from the second roll of material and the second wall 104 (see e.g., FIG. 1A) from the first roll of material. Using this example, the bag-converting machine can then form the reinforced polybags 100 by attaching the side edges 102a, 102c and 104d of the first wall 102 with the side edges 104c, 104a, and 104d of the second wall 104, respectively (see e.g., FIG. 1A). The bag-converting machine can form these attachments by at least one of i) heat sealing, ii) ultrasonic welding, and iii) lamination.

Reference is now made to FIG. 9 to show another example of what material may be provided to the bag-converting machine to manufacture the reinforced polybag 100. In this example, the bag-converting machine may be provided with a single roll of material only. FIG. 9 shows a length of this material. As shown, the roll of material is a length of the synthetic resin film 2012′ collected at the second spool 2004 of the machine 2000. That is, the synthetic resin film 2012′ can have the length of synthetic resin fiber mesh 2020 attached at attachment regions 118 around the holes 108. The length of the synthetic resin film 2012′ collected at the third spool 2004 differs from the length of synthetic resin film 2012 collected at the third spool 2004 in the positioning of the holes 108 and the corresponding attachment regions 118 formed around the holes 108. The holes 108 in the length of synthetic resin film 2012′ can be provided by the first die 2016 (FIG. 6) at a location between a center line 2028 of the synthetic resin film 2012′ and a bottom (or top) side edge 2030 of the synthetic resin film 2012′. Accordingly, the bag-converting machine can cut the first wall 102 (see e.g., FIG. 1A) and the second wall 104 (see e.g., FIG. 1A) from this single roll of material with the first wall 102 and the second wall being attached along the center line 2028. Using this example, the bag-converting machine can then form the reinforced polybags 100 by attaching the side edges 102a, 102c of the first wall 102 with the side edges 104c, 104a of the second wall 104, respectively (see e.g., FIG. 1A). Similarly, the bag-converting machine can form these attachments by at least one of i) heat sealing, ii) ultrasonic welding, and iii) lamination. In this particular example, no attachment is needed between the fourth side wall 102d of the first side wall 102 and the fourth side wall 104d of the second wall 104 as these side edges can be formed by folding the synthetic resin film 2012′ at the center line 2028. The reduction in the number of attachments between side edges of adjoining walls can provide the reinforced polybag 100 with improved structural integrity.

While the above description provides examples of one or more apparatus, methods, or systems, it will be appreciated that other apparatus, methods, or systems may be within the scope of the claims as interpreted by one of skill in the art.

1. A method of making a reinforced polybag, the method comprising:
providing a plurality of walls formable into the polybag, each wall in the plurality of walls being made of a synthetic resin film and being attachable along at least one side edge to at least one side edge of at least one adjoining wall in the plurality of walls;
providing a hole in a wall in the plurality of walls, such that a remaining portion of the wall separates the hole in the wall from a side edge of the at least one side edge of the wall;
forming the polybag out of the plurality of walls by attaching each wall in the plurality of walls along the at least one side edge of that wall to the at least one side edge of the at least one adjoining wall in the plurality of walls;
providing a synthetic resin fiber mesh cover to cover the hole in the wall; and,
attaching a peripheral portion of the synthetic resin fiber mesh cover to the remaining portion of the wall to cover the hole in the wall.

2. The method as defined in claim 1, wherein
the at least one side edge of the wall comprises a plurality of side edges of the wall; and,
providing the hole in the wall, comprises providing the hole in the wall, such that the remaining portion of the wall separates the hole in the wall from each side edge of the plurality of side edges of the wall.

3. The method as defined in claim 1, wherein attaching the peripheral portion of the synthetic resin fiber mesh cover to the remaining portion of the wall comprises attaching the peripheral portion of the synthetic resin fiber mesh cover to an inner sub-portion of the remaining portion of the wall adjacent the hole, such that an outer sub-portion of the remaining portion of the wall remains uncovered by of the synthetic resin fiber mesh.

4. The method as defined in claim 1 further comprising providing indicia on the remaining portion of the wall.

5. The method as defined in claim 3 further comprising providing indicia on the outer sub-portion of the remaining portion of the wall.

6. The method as defined in claim 3 wherein attaching the peripheral portion of the synthetic resin fiber mesh cover to the remaining portion of the wall comprises heat-sealing the peripheral portion of the synthetic resin fiber mesh cover to the inner sub-portion of the remaining portion of the wall.

7. The method as defined in claim 3 wherein attaching the peripheral portion of the synthetic resin fiber mesh cover to the remaining portion of the wall comprises ultrasonically welding the peripheral portion of the synthetic resin fiber mesh cover to the inner sub-portion of the remaining portion of the wall.

8. The method as defined in claim 3 wherein attaching the peripheral portion of the synthetic resin fiber mesh cover to the remaining portion of the wall comprises laminating the peripheral portion of the synthetic resin fiber mesh cover to the inner sub-portion of the remaining portion of the wall.

9. The method as defined in claim 1 further comprising providing a first die and a second die, distinct from the first die, wherein
providing the hole in the wall comprises operating the first die to provide the hole in the wall; and
attaching the peripheral portion of the synthetic resin fiber mesh cover to the remaining portion of the wall to cover the hole in the wall, comprises drawing the synthetic resin fiber mesh cover over the hole and then operating the second die to attach the peripheral portion of the synthetic resin fiber mesh cover to the remaining portion of the wall to cover the hole in the wall.

10. The method as defined in claim 9, wherein the second die is a heat sealing die dimensioned to heat seal around the hole in the wall.

11. The method as defined in claim 9, wherein the second die is an ultrasonic welding die dimensioned to ultrasonically weld around the hole in the wall.

12. The method as defined in claim 9, wherein the second die is a laminating die dimensioned to laminate around the hole in the wall.

13. The method as defined in claim 1 wherein forming the polybag out of the plurality of walls comprises first cutting the plurality of walls and then, for each wall in the plurality of walls, attaching the at least one side edge of that wall to the at least one side edge of the at least one adjoining wall in the plurality of walls by at least one of i) heat sealing the at least one side edge of that wall to the at least one side edge of the at least one adjoining wall in the plurality of walls, ii) ultrasonically welding the at least one side edge of that wall to the at least one side edge of the at least one adjoining wall in the plurality of walls, and iii) laminating the at least one side edge of that wall to the at least one side edge of the at least one adjoining wall in the plurality of walls.

14. The method as defined in claim 13 wherein attaching the peripheral portion of the synthetic resin fiber mesh cover to the remaining portion of the wall to cover the hole in the wall precedes forming the polybag out of the plurality of walls.

15. A reinforced polybag comprising:
a plurality of walls, each wall in the plurality of walls being made of a synthetic resin film and being attached along at least one side edge to at least one side edge of at least one adjoining wall in the plurality of walls, wherein at least one wall in the plurality of walls comprises a hole in the wall and a remaining portion separating the hole in the wall from a side edge of the at least one side edge of the wall;
a synthetic resin fiber mesh covering the hole in the wall, a peripheral portion of the synthetic resin fiber mesh cover being attached to the remaining portion of the wall to cover the hole in the wall.

16. The reinforced polybag as defined in claim 15, wherein
the at least one side edge of the wall comprises a plurality of side edges of the wall; and,
the remaining portion of the wall separates the hole in the wall from each side edge of the plurality of side edges of the wall.

17. The reinforced polybag as defined in claim 15, wherein
the remaining portion of the wall comprises an inner sub-portion adjacent the hole and an outer sub-portion between the inner sub-portion and the at least one side edge of the wall; and,
the peripheral portion of the synthetic resin fiber mesh cover is attached to the inner sub-portion of the remaining portion of the wall, and an outer sub-portion of the remaining portion of the wall is uncovered by the synthetic resin fiber mesh cover.

18. The reinforced polybag as defined in claim 15 further comprising indicia on the remaining portion of the wall.

19. The reinforced polybag as defined in claim 17 further comprising indicia on the outer sub-portion of the remaining portion of the wall.

20. The reinforced polybag as defined in claim 17 wherein the peripheral portion of the synthetic resin fiber mesh cover is heat-sealed to the inner sub-portion of the remaining portion of the wall.

21. The reinforced polybag as defined in claim 17 wherein the peripheral portion of the synthetic resin fiber mesh cover is ultrasonically welded to the inner sub-portion of the remaining portion of the wall.

22. The reinforced polybag as defined in claim 17 wherein the peripheral portion of the synthetic resin fiber mesh cover is laminated to the inner sub-portion of the remaining portion of the wall.

23. The reinforced polybag as defined in claim 15, wherein, for each wall in the plurality of walls, the at least one side edge of that wall is attached to the at least one side edge of the at least one adjoining wall in the plurality of walls, by at least one of i) heat sealing, ii) ultrasonic welding, and iii) lamination.

24. The reinforced polybag as defined in claim 15 wherein the synthetic resin film comprises at least one of polyethylene (PE), liner low density polyethylene (LLDPE), cast polypropylene (CPP), biaxially oriented polypropylene (BOPP), polyethylene terephthalate (PET) and nylon.
